(19) United States
(12) Patent Application Publication
(10) Pub. No.: US 2019/0111939 A1
(43) Pub. Date: Apr. 18, 2019

(54) MILES TO EMPTY ACCURACY ENHANCEMENT

(71) Applicant: FORD GLOBAL TECHNOLOGIES, LLC, Dearborn, MI (US)

(72) Inventors: Joseph Norman ULREY, Dearborn, MI (US); Ross Dykstra PURSIFULL, Dearborn, MI (US); William Charles RUONA, Farmington Hills, MI (US)

(21) Appl. No.: 15/783,605

(22) Filed: Oct. 13, 2017

(51) Int. Cl. B60W 50/14; B60W 20/13; B60L 11/12; B60L 11/18

(52) U.S. Cl. CPC B60W 50/14; B60W 20/13; B60K 6/44; B60L 11/1862; B60L 11/123

(57) ABSTRACT

A system for a vehicle includes an engine and an electric motor each configured to power the vehicle, and a controller configured to, responsive to both an engine-only drive range being less than a threshold and a drive mode being electric-only, operate an engine to charge a battery to deplete fuel for the engine and to reduce the engine-only drive range toward zero, and responsive to the engine-only drive range becoming zero, generate an alert.

### TECHNICAL FIELD

The present disclosure relates to systems and methods for increasing accuracy of displayed available vehicle range.

### BACKGROUND

Many modern vehicles have two energy storage systems capable of moving the vehicle. The case in point is the hybrid vehicle and the plug-in hybrid vehicle which operate on gasoline or battery energy. In some cases, novice operators of the vehicles having multiple energy sources have demonstrated a penchant for running out of gasoline. The existing algorithms for using the energy sources are conventionally arranged. First, use the ecologically-favorable (or low cost) energy source, followed by the conventional fuel source, gasoline. While this algorithm is sufficient when considered strictly from an engineering point of view, this approach may not optimize the useful range of the vehicle.

### SUMMARY

A system for a vehicle includes an engine and an electric motor each configured to power the vehicle, and a controller configured to, responsive to both an engine-only drive range being less than a threshold and a drive mode being electric-only, operate an engine to charge a battery to deplete fuel for the engine and to reduce the engine-only drive range toward zero, and responsive to the engine-only drive range becoming zero, generate an alert.

A method for a vehicle includes, by a controller, responsive to both an engine-only drive range being less than a threshold and a drive mode being electric-only, operating an engine to charge a battery to deplete fuel for the engine and to reduce the engine-only drive range toward zero, and responsive to the engine-only drive range becoming zero, generating an alert.

A system for a vehicle includes an engine and an electric motor each configured to power the vehicle, and a controller configured to, responsive to both an engine-only drive range being less than a first threshold and a drive mode being electric-only, operate an engine to charge a battery to deplete fuel for the engine and to reduce the engine-only drive range toward zero, and, responsive to battery SOC being greater than a second threshold, discontinue charging the battery.

### BRIEF DESCRIPTION OF THE DRAWINGS

FIGS. 1A-1B are block diagrams illustrating a plug-in hybrid electric vehicle (PHEV) having a display including a fuel level gauge and an electric range indicator;

FIGS. 2A-2B are block diagrams illustrating a dual-level indicator and a fuel range alert display; and

FIG. 3 is a flowchart illustrating an algorithm for enhancing accuracy of a fuel range display.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

A reduced-emissions vehicle may include one or more sources of power, such as, but not limited to, a gasoline or a diesel engine, a traction battery, and so on. The vehicle may be configured to selectively enable and disable the power sources in response to detecting that one or more predefined criteria has been met. The vehicle may, accordingly, operate in one or more operating modes based on the source(s) supplying propulsion energy, such as, but not limited to, an engine-only operating mode with the engine supplying most the propulsion energy, an electric mode with the traction battery supplying all or most the propulsion energy, and so on.

The vehicle may be further configured to operate one or more power sources to maintain or assist another power source of the vehicle. The vehicle may be configured, for example, to operate the engine to affect an operating mode of the traction battery and vice versa. As one example, the vehicle may be configured to operate the engine to selectively, periodically, or continuously charge and/or discharge the traction battery. As another example, the vehicle may be configured to operate the engine to selectively, periodically, or continuously maintain a charge level of the traction battery, or any combination thereof.

The vehicle may, accordingly, be configured to regulate the operating modes of the traction battery based on one or more operating parameters indicative of the traction battery performance, such as, but not limited to, battery capacity, open circuit voltage, terminal voltage, practical capacity, discharge rate, state of charge (SOC), state of discharge (SOD), depth of discharge (DOD), battery energy, specific energy, battery power, specific power, and so on. As one example, the vehicle may be configured to determine total energy of the traction battery based on one or more of battery capacity and discharge voltage. The use of other values, parameter states, measurements, and data points is also contemplated.

The operating modes of the vehicle may be further defined based on an amount of the propulsion energy provided by the one or more sources of power, i.e., engine assist, battery assist, engine-only, battery-only operating modes, as some examples. The operating modes may be further defined by an amount of emissions output by the vehicle, such as, but not limited to, one or more of a particulate matter (PM), hydrocarbons (HC), nitrogen oxides (NOx), carbon monoxide (CO), sulfur dioxide (SO2), toxics, and greenhouse gases. As one example, the electric silent drive mode may include an operating mode of the vehicle where vehicle emissions are diminished, minimized, or eliminated, as compared to other operating modes.

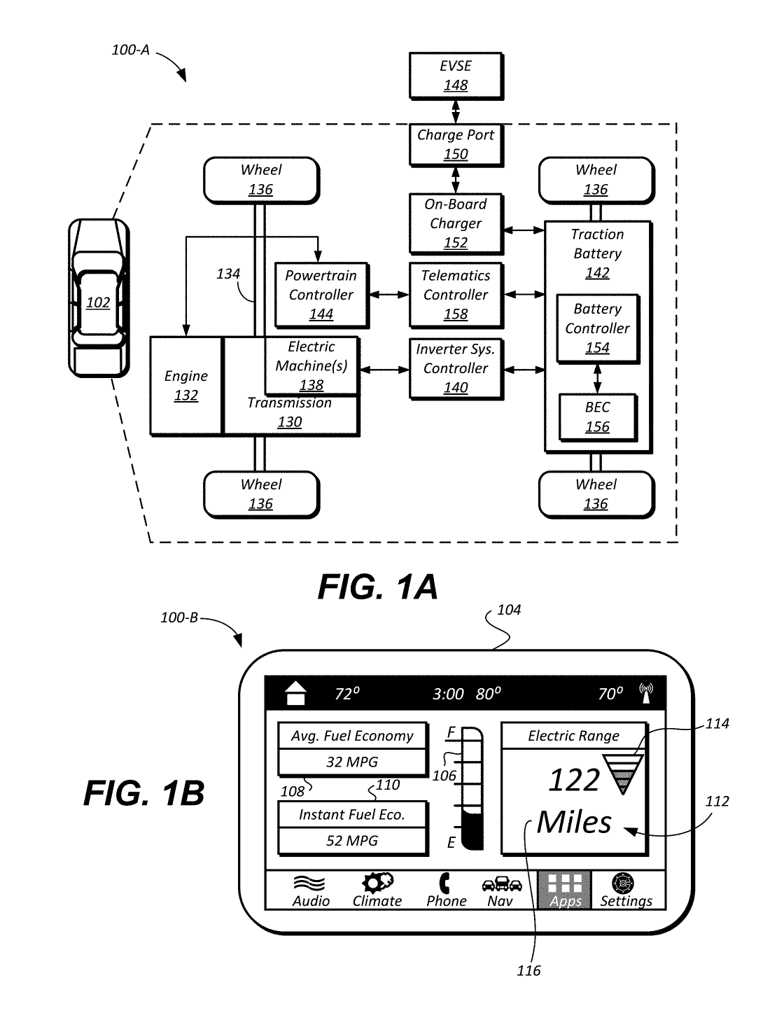

FIG. 1A illustrates an example plug-in hybrid-electric vehicle (PHEV) power system 100-A of a vehicle 102. The vehicle 102 may comprise a hybrid transmission 130 mechanically connected to an engine 132 and a drive shaft 134 driving wheels 136. A powertrain controller 144 configured to provide control of the engine 132 operating components (e.g., idle control components, fuel delivery components, emissions control components, etc.) and monitoring of the engine 132 operating components (e.g., status of engine diagnostic codes).

The hybrid transmission 130 may also be mechanically connected to one or more electric machines 138 capable of operating as a motor or a generator. The electric machines 138 may be electrically connected to an inverter system controller (hereinafter, inverter) 140 providing bi-directional energy transfer between the electric machines 138 and at least one traction battery 142.

The traction battery 142 typically provides a high voltage (HV) direct current (DC) output. In a motor mode, the inverter 140 may convert the DC output provided by the traction battery 142 to a three-phase alternating current (AC) as may be required for proper functionality of the electric machines 138. In a regenerative mode, the inverter 140 may convert the three-phase AC output from the electric machines 138 acting as generators to the DC required by the traction battery 142. In addition to providing energy for propulsion, the traction battery 142 may provide energy for high voltage loads (not illustrated), such as compressors and electric heaters, and low voltage loads (not illustrated), such as electrical accessories, an auxiliary 12 V battery, and so on.

The vehicle 102 may be configured to recharge the traction battery 142 via a connection to a power grid. The vehicle 102 may, for example, cooperate with electric vehicle supply equipment (EVSE) 148 of a charging station to coordinate the charge transfer from the power grid to the traction battery 142. In one example, the EVSE 148 may have a charge connector for plugging into a charge port 150 of the vehicle 102, such as via connector pins that mate with corresponding recesses of the charge port 150. The charge port 150 may be electrically connected to an on-board power conversion controller (hereinafter, charger) 152. The charger 152 may condition the power supplied from the EVSE 148 to provide the proper voltage and current levels to the traction battery 142. The charger 152 may interface with the EVSE 148 to coordinate the delivery of power to the vehicle 102.

The traction battery 142 may include a battery controller 154 configured to manipulate a plurality of connectors and switches of a bussed electrical center (BEC) 156 to enable the supply and withdrawal of electric energy to and from the traction battery 142. The battery controller 154 may be configured to determine one or more operating parameters corresponding to the traction battery 142 based on one or more measured and/or estimated properties of the traction battery 142. The battery controller 154 may be electrically connected to and in communication with one or more other vehicle controllers.

Each of the powertrain controller 144 and the battery controller 154 may be electrically connected to and in communication with a telematics controller 158 connected with an in-vehicle display, such as the display 104 illustrated, for example, in FIG. 1B. The vehicle 102 may also provide one or more audio outputs to an input of the audio playback functionality of an audio module and/or provide audio output to the occupants through use of one or more dedicated speakers (not illustrated).

The display 104 may also receive input from human-machine interface (HMI) controls, e.g., one or more buttons, configured to provide for occupant interaction with the vehicle 102 to invoke vehicle 102 functions (e.g., steering wheel audio buttons, a push-to-talk button, instrument panel controls, etc.). The display 104 may be further configured to communicate with other components of the vehicle 102 via one or more in-vehicle networks, such as, but not limited to, one or more of a vehicle controller area network (CAN), an Ethernet network, and a media oriented system transfer (MOST), as some examples. Thus, the display 104 may be configured to display, for example, current vehicle 102 location and heading information, as well as, various other types of information provided by various controllers of the vehicle 102.

In some examples, the powertrain controller 144 and the battery controller 154 may be electrically connected to and in communication with one or more other vehicle controllers (not illustrated), such as, but not limited to, a body controller configured to manage various power control functions such as exterior lighting, interior lighting, keyless entry, remote start, and point of access status verification (e.g., closure status of the hood, doors and/or trunk of the vehicle 102); a radio transceiver configured to communicate with key fobs or other local vehicle 102 devices; and a climate control management controller configured to provide control and monitoring of heating and cooling system components (e.g., compressor clutch and blower fan control, temperature sensor information, etc.).

In some cases, the display 104, as illustrated in FIG. 1B, may be a touch screen further configured to receive user touch input, e.g., via a connected video controller and so on, while in other cases the display 104 may be a display only, without touch input capabilities. The display 104 may be a stand-alone or integrated display that is part of a passenger compartment centerstack, dashboard panel, driver notification center or another suitable location within the vehicle 102. The display 104 may be configured to display driver notifications, such as, but not limited to, navigation information, weather, audio/video output, and so on.

A control strategy in selecting among multiple energy sources of a given vehicle (e.g. battery and electricity) may be directed to optimizing one or more factors, such as, but not limited to, fuel economy, fuel cost, and environmental emissions. In one example, in response to detecting that electric-only range of the vehicle 102 is less than a predefined threshold, e.g., based on SOC or another monitored parameter, the battery controller 154 may be configured to send a signal to the powertrain controller 144 indicating that engine-only operating mode should be enabled.

The control strategy for selecting among energy sources, however, may not provide to a user with a desired fueling flexibility. In one example, a driver may desire to conserve a certain type of fuel and use the other fuel instead. As another example, the driver may desire to cause the vehicle 102 to operate in electric-only drive mode in the cities or near recharging stations, since access to a charge station for replenishing battery charge may be readily available.

In a vehicle 102 including multiple sources of energy, each source may use a same or different sensor system and/or algorithm to determine a drive range available, i.e., remaining, before empty. The battery controller 154 may be configured to determine electric-only drive range with a great accuracy. In one example, the battery controller 154 may be configured to determine electric-only drive range to within a relatively narrow threshold (±0.2 miles) for all levels of battery charge, e.g., full charge, half-charge, low charge, etc. The powertrain controller 144 may be configured to receive a signal from one or more fuel level sensors (not illustrated) and may determine an engine-only range of the vehicle 102 based on the signal. However, as the fuel level reaches a predefined threshold, accuracy of the fuel sensor may decrease and the powertrain controller 144 determine the engine-only range of the vehicle 102, but within a wide threshold (±20 miles).

The powertrain controller 144 and the battery controller 154 may send a signal indicative of the detected (and/or computed) engine-only range and electric-only range, respectively, to the display 104. As shown in FIG. 1B, the electric-only drive range may be displayed via a battery range indicator 112 and the engine-only drive range may be displayed via a fuel level indicator 106. In one example, the battery range indicator 112 may be a numerical value (e.g., in miles) and the fuel level indicator 106 may be a relative scale indicating a range of fuel levels, such as, full tank of gas, half-full tank of gas, a quarter-full tank of gas, and so on. While the battery range indicator 112 illustrated in FIG. 1B is a numerical value and the fuel level indicator 106 is a scale indicator, the present disclosure is not so limited. The fuel level indicator 106 may, for instance, include (or be supplemented with) a numerical value indicator and the battery range indicator may include, or be supplemented with, a battery charge scale indicator.

Moreover, the fuel level indicator 106 and the battery range indicator 112 may be further supplemented with one or more fuel economy indicators, such as, but not limited to, an average fuel economy indicator 108, an instant fuel economy indicator 110, and so on. The supplemental indicators 108, 110 may be configured to display average and instant fuel economy, respectively, related to one of or a combination of the energy sources 132, 142 of the vehicle 102. Other display 104 configuration, including additional or alternative features, indicators, and scales, are also contemplated.

For example, the fuel level indicator 106 may have an upper scale value identified as “F” for a “full” tank of gas and a lower scale value identified as “E” for an “empty” tank of gas. Furthermore, the fuel level indicator 106 may include additional lights, such as, for example, a “LOW FUEL” light activated by the powertrain controller 144 in response to detecting that fuel level of the vehicle 102 is less than a threshold. In some instances, accuracy (or tolerance) of the remaining drive range of a given energy source may be a function of one or more operating characteristics of its sensors. A fuel level sensor (not illustrated) may include a small circuit board and may be distributed as part of a fuel pump assembly of the vehicle. In some examples, the fuel level sensor may be configured to communicate with other components of the fuel system before delivering a signal to the instrument panel.

The fuel level sensor may include a sensing unit (not illustrated) and a fuel level indicator. The sensing unit may, for example, be a float, and as the fuel level rises and the float nears the top of the tank, value of the variable resistor approaches ground, signaling very little resistance and a larger amount of current passing through the sending unit back to the fuel level indicator. Furthermore, as the float sinks lower, the connection over the resistor changes, maximizing its resistance, and will eventually trigger a low fuel light. Fuel level sensors may, for example, also include magnetic, non-magnetic, and/or non-contacting sensors. In some instances, the sensor may convert rotary motion into an electrical signal to provide a fuel level measurement.

In a vehicle equipped with the traction battery 142 and the engine 132, for example, a battery controller may be configured to issue one or more commands to selectively enable and disable the engine 132 and/or the battery 142 responsive to one or more predefined operating conditions having being met. The powertrain controller 144 and the battery controller 154 may be configured to prioritize use of an electric-only drive range supplied by the traction battery 142 over engine-only drive range supplied by the engine 132 and are configured to use the electricity first (reserving a 1- to 3-mile buffer for HEV operation), then switching to gasoline operation. In one example, in response to detecting that electric-only drive range of the traction battery 142 is less than a predefined threshold, the battery controller 154 may be configured to send a signal to the powertrain controller 144 indicating that a switch to engine-only drive mode is necessary. While this is usually the best approach, it is a poor approach when the guaranteed gasoline range hits zero. This is because if gasoline (any liquid fuel) is the last energy source used, one has an unpredictable amount of usable fuel. The vehicle may have 40 more miles on it or it may have zero.

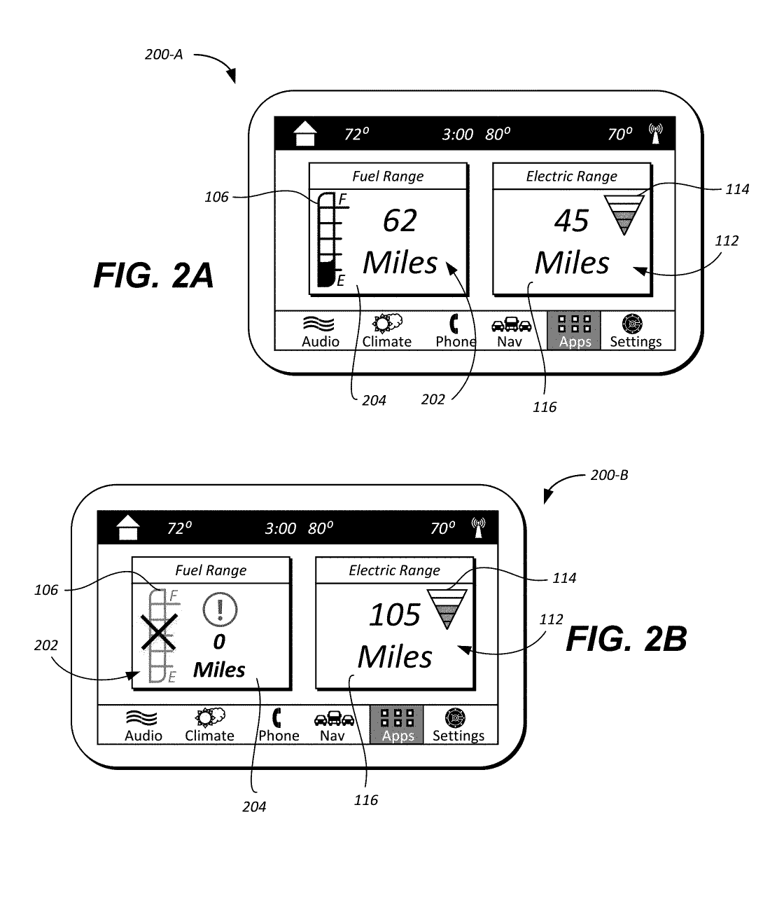

FIGS. 2A-2B illustrate example user displays 200-A and 200-B, respectively, for enhancing accuracy of the indicated fuel range of the vehicle 102. The display 200-A may include the engine-only drive range indicator 202 having the fuel level indicator 106. Additionally or alternatively, the engine-only drive range indicator 202 may include a numerical fuel indicator 204 electrically connected to the powertrain controller 144. Each of the fuel level indicator 106 and the numerical fuel indicator 204 may be configured to display, based on a corresponding signal from the powertrain controller 144, one of a relative scale approximation or a numerical value of remaining engine-only drive range of the vehicle 102.

As illustrated in FIG. 2B, the display 200-B may be configured to indicate that engine-only drive range of the vehicle 102 is zero based on a corresponding signal from the powertrain controller 144. In one example, the fuel level indicator 106 of the engine-only drive range indicator 202 may display a notification that the amount of available engine fuel is zero. Additionally or alternatively, the numerical fuel indicator 204 of the engine-only range indicator 202 may display a notification that 0 (zero) gasoline miles remain to empty, e.g., “0 Miles.”

The powertrain controller 144 may be configured to issue a command to activate the engine 132 of the vehicle 102 in response to detecting that fuel level is less a first threshold, e.g., 10 miles. In one example, the powertrain controller 144 may be configured to determine that the fuel level is less than a first threshold in response to, or concurrently with, activation of a “LOW FUEL” light of the fuel level indicator 106, detecting that resistance across the fuel level sensor is greater than a predefined value, detecting that accuracy level of the fuel level sensor is less than a predefined level, and so on. Responsive to the fuel level and/or engine-only drive range being below a first threshold, the powertrain controller 144, e.g., in cooperation with the battery controller 154, may be configured to activate the engine 132 to charge the traction battery 142.

The powertrain controller 144 may continue monitoring the fuel level of the vehicle 102 while the engine 132 is activated and charging the traction battery 142. Furthermore, the powertrain controller 144 may be configured to send a “0 Miles” signal to the fuel-level indicator 106 and the numerical fuel indicator 204 in response to detecting that fuel level of the vehicle 102 is less than a second threshold, e.g., ˜0 miles. The powertrain controller 144 may determine that the fuel level is less than a second threshold, i.e., the engine-only drive range of the vehicle 102 is zero in response to receiving a corresponding signal from one or more components of the fuel system, such as, but not limited to, the fuel level sensor, fuel pump, and so on.

Thus, the powertrain controller 144 may be configured to activate the engine 132, thereby, switching the vehicle 102 at least partly to gasoline operation, to convert remaining gasoline to electricity to replenish the traction battery 142. In one example, the powertrain controller 144 may convert a predefined amount of gasoline to electricity, e.g., up to 10 electric miles, to drive fuel level of the vehicle 102 toward zero such that the vehicle 102 may run out of gas or may not have a sufficient amount of gasoline to continue fuel pump operation. The powertrain controller 144 may be configured to notify the vehicle operator, e.g., via the engine-only drive range indicator 202 described in reference to FIGS. 2A-2B, that the tank now has zero usable fuel and engine operation is not available. The control strategy for the vehicle 102 may include displaying to the operator a number of electric miles that remain to empty, as well as, periodically reminding the operator that gasoline operation is unavailable.

Furthermore, the control strategy of the vehicle 102 may further include one or more energy conservation procedures implemented by one or more of the powertrain controller 144 and the battery controller 154, such as, but not limited to, shutting off a heating ventilation and A/C (HVAC) system when electric-only range is less than a predefined threshold, e.g., less than 2.5 miles. As some other examples, the energy conservation procedures may be implemented gradually as the drive range decreases with time. Thus, some performance limits may be activated when a range is less than a first threshold, e.g., 20 miles, while other performance limits may be activated when a range is less than a second threshold less than the first, e.g., 5 miles. Moreover, one or more features, systems, or functions of the vehicle may be exempted from being disabled under the energy conservation procedures, such as, but not limited to, front window defrost system.

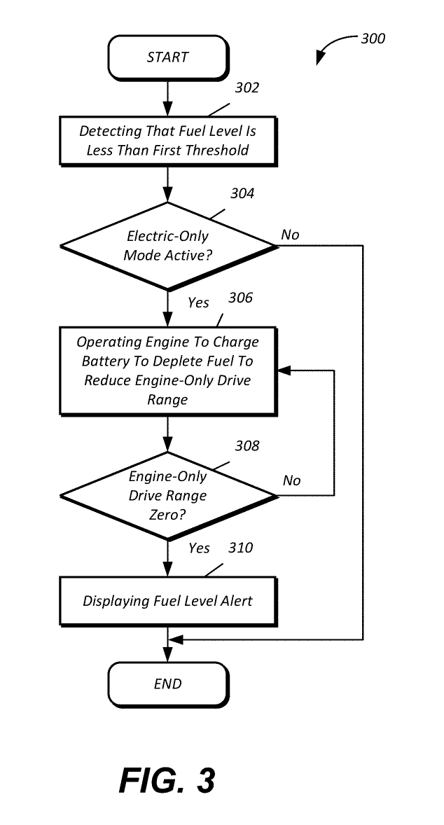

FIG. 3 illustrates an example control strategy 300 for enhancing accuracy of the fuel range display. The control strategy 300 may increase accuracy of the fuel range display of the vehicle 102 including two sources of propulsion energy, such as, but not limited to, the traction battery 142 and the engine 132. The strategy 300 may begin at operation 302 where the powertrain controller 144 detects that fuel level of the vehicle 102 is less than a first threshold. In one example, the powertrain controller 144 may determine that the fuel level is less than a first threshold in response to, or concurrently with, activation of a “LOW FUEL” light of the fuel level indicator 106, detecting that resistance across the fuel level sensor is greater than a predefined value, detecting that accuracy level of the fuel sensor is less than a predefined level, and so on.

Responsive to the fuel level and/or engine-only drive range being below a first threshold, the powertrain controller 144 may determine, at operation 304, whether the vehicle 102 is operating in electric-only operating mode, e.g., the traction battery 142 is a main source of propulsion, and so on. If the electric-only operating mode is not active, the powertrain controller 144 may exit the control strategy 300. An example of the vehicle 102 not operating in the electric-only mode may be during a high torque demand or other situation where the engine 132 may be providing a portion of the propulsion power.

In response to determining, at operation 304, that the vehicle 102 is in electric-only operating mode, the powertrain controller 144, e.g., in cooperation with the battery controller 154, may, at operation 306, issue one or more commands to activate the engine 132 to charge the traction battery 142 to deplete gasoline fuel to reduce the engine-only drive range of the vehicle 102.

The powertrain controller 144 may continue monitoring the fuel level of the vehicle 102 while the engine 132 is activated and charging the traction battery 142. At operation 308, the powertrain controller 144 may determine whether the engine-only range of the vehicle 102 is zero. In some examples, the engine-only range of the vehicle 102 may be zero when the fuel level is less than a second threshold, e.g., when a signal from one or more components of the fuel system indicates that the fuel level may not have a sufficient amount of gasoline to continue fuel pump operation, and so on. The powertrain controller 144 may be configured to return to operation 306 responsive to detecting that the engine-only range of the vehicle 102 is not zero.

Responsive to detecting, at operation 308, that the engine-only range of the vehicle 102 is zero, the powertrain controller 144, at operation 310, may send a signal to the engine-only drive range indicator 202 to display an alert. In one example, the fuel level indicator 106 of the engine-only drive range indicator 202 may display a notification that the amount of available engine fuel is zero. Additionally or alternatively, the numerical fuel indicator 204 of the engine-only range indicator 202 may display a notification that 0 (zero) gasoline miles remain to empty, e.g., “0 Miles.” The control strategy 300 for the vehicle 102 may include displaying to the operator a number of electric miles that remain to empty, e.g., via the electric-only drive range indicator 112, as well as, periodically reminding the operator that gasoline operation is unavailable.

The control strategy 300 of the present disclosure may operate to maximize the use of the energy source having a highly predictable drive range, such as, the traction battery 142, while not diminishing the theoretical maximum range of the energy source having a less predictable (or less accurately predictable) drive range. Switching the “preferred energy source” automatically at “0 gasoline miles to empty” may allow the vehicle 102 operator to use all the gasoline on the vehicle 102 while displaying a highly accurate remaining range-to-empty.

Moreover, the control strategy of the present disclosure may be applied to vehicles using other types of fuels, energy sources, and other combinations of multiple energy sources. In some examples, the fuels may include one or more of compressed natural gas (CNG), liquefied petroleum gas (LPG), as well as, fuels that are primarily hydrogen, and so on. The future moment when one will run out of gasoline has a large amount of uncertainty in it. However, there is far less uncertainty with a gaseous fuel whose availability is predictable via the tank pressure. Thus, by saving the last 10 miles of CNG fuel would allow one to use all the gasoline on board while retaining a highly accurate distance to empty (for the last 10 miles). As is the case with the gasoline, switching the fuel use strategy near the very end of fuel availability may allow to completely use the uncertain fuel first, finishing with the fuel (or battery) whose energy reserve is known with great accuracy.

The processes, methods, or algorithms disclosed herein may be deliverable to or implemented by a processing device, controller, or computer, which may include any existing programmable electronic control unit or dedicated electronic control unit. Similarly, the processes, methods, or algorithms may be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms may also be implemented in a software executable object. Alternatively, the processes, methods, or algorithms may be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

The words used in the specification are words of description rather than limitation, and it is understood that various changes may be made without departing from the spirit and scope of the disclosure. As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A system for a vehicle, comprising:
an engine and an electric motor each configured to power the vehicle; and
a controller configured to, responsive to both an engine-only drive range being less than a threshold and a drive mode being electric-only, operate an engine to charge a battery to deplete fuel for the engine and to reduce the engine-only drive range toward zero, and responsive to the engine-only drive range becoming zero, generate an alert.

2. The system of claim 1, wherein the alert indicates that the engine-only drive range is zero and that electric-only drive range is a total drive range.

3. The system of claim 1, wherein the controller is further configured to discontinue charging of the battery responsive to drive torque demand being greater than a first threshold.

4. The system of claim 1, wherein the controller is further configured to monitor a state-of-charge (SOC) of the battery during the operation of the engine to charge the battery, and to stop the charging responsive to the SOC being above a second threshold.

5. The system of claim 1, wherein the controller is further configured to stop the charging responsive to an amount of charge transferred corresponding to a predefined number of miles of electric-only drive range.

6. The system of claim 1, wherein the engine-only drive range is zero when a remaining fuel amount is less than a fuel pump operating amount.

7. The system of claim 1, wherein the controller is further configured to determine that the engine-only drive range is less than the threshold responsive to detecting that a “LOW FUEL” light is activated.

8. The system of claim 1, wherein the controller is further configured to determine that the engine-only drive range is less than the threshold responsive to detecting that accuracy of a fuel level sensor is less a predefined accuracy level.

9. A method for a vehicle, comprising:
by a controller,
responsive to both an engine-only drive range being less than a threshold and a drive mode being electric-only, operating an engine to charge a battery to deplete fuel for the engine and to reduce the engine-only drive range toward zero; and
responsive to the engine-only drive range becoming zero, generating an alert.

10. The method of claim 9, wherein the alert indicates that the engine-only drive range is zero and that electric-only drive range is a total drive range.

11. The method of claim 9 further comprising, responsive to drive torque demand being greater than a first threshold during the operating of the engine to charge the battery, discontinuing the charging of the battery.

12. The method of claim 9 further comprising monitoring a state-of-charge (SOC) of the battery during the operation of the engine to charge the battery, and, responsive to the SOC being above a second threshold, stopping the charging of the battery.

13. The method of claim 9 further comprising stopping the charging responsive to an amount of charge transferred corresponding to a predefined number of miles of electric-only drive range.

14. The method of claim 9, wherein the engine-only drive range is zero when a remaining fuel amount is less than a fuel pump operating amount.

15. The method of claim 9, wherein the engine-only drive range being less than the threshold is responsive to a “LOW FUEL” light being activated.

16. A system for a vehicle, comprising:
an engine and an electric motor each configured to power the vehicle; and
a controller configured to,
responsive to both an engine-only drive range being less than a first threshold and a drive mode being electric-only, operate an engine to charge a battery to deplete fuel for the engine and to reduce the engine-only drive range toward zero, and,
responsive to battery SOC being greater than a second threshold, discontinue charging the battery.

17. The system of claim 16, wherein the controller is further configured to generate an alert indicating that the engine-only drive range is zero and that electric-only drive range is a total drive range.

18. The system of claim 16, wherein the engine-only drive range is zero when a remaining fuel amount is less than a fuel pump operating amount.

19. The system of claim 16, wherein the engine-only drive range being less than the first threshold is responsive to a “LOW FUEL” light being activated.

20. The system of claim 16, wherein the engine-only drive range is less than the first threshold responsive to detecting that accuracy of a fuel level sensor is less a predefined accuracy level.
